(19) United States
(12) Patent Application Publication
(10) Pub. No.: US 2003/0077067 A1
(43) Pub. Date: Apr. 24, 2003

(54) Television program editing device

(75) Inventors: Chien-Ming Wu, Taipei (TW); Hsien-Fen Hsieh, Panchiao City (TW)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 09/983,203

(22) Filed: Oct. 23, 2001

(51) Int. Cl. G11B 27/00

(52) U.S. Cl. 386/52

(57) ABSTRACT

A television program editing device includes an input portion for receiving input data, an identity verification portion for inspecting identity and authority of the editor, an internal data storage portion for storing data read from the external storage device, a data processing portion for processing data inquiries and changes, a changed data buffer portion for recording data revised by the editor, a data access portion communicated with the external storage device, and a display portion for exhibiting program guide data to the editor.

### BACKGROUND OF THE INVENTION

1. Field of the Invention

This invention relates to a television program editing device applied to television broadcasting ends and television stations for editing and storing digital television electronic program guide data in an external storage device.

2. Description of the Related Art

According to the rules of television broadcasting signal digitalization, a 6-MHz broadcasting channel bandwidth assigned to each television station can be used to simultaneously transmit four or more television programs by employing digital compression techniques, with no effect on the quality of the broadcast programs. Therefore, with the digitalization of television broadcasting, viewers can have many television programs available for selection at the same time. Therefore, the rules for digital television generally include rules governing program guide related information, so that the viewers can select the programs they want to watch from the program guides on the television set directly.

In order for the viewers to smoothly browse the program guides on television, in addition to basic signals, such as video signals and audio signals, a television station has to insert program guide data into the broadcasting signal. Therefore, the television station must have a device capable of editing and storing program guide data so as to insert program guide data into broadcasting signals.

With the advancement in the art of broadcasting and digital video signal compression, the traditional analog television broadcasting method is going to be replaced by the latest digital television broadcasting techniques. Many advanced countries in the world have planned to replace analog television broadcasting with digital television broadcasting in the next few years. According to the standard of digital television broadcasting, television broadcasting signals must include program guide data. Therefore, the television broadcasting ends need to have a device capable of editing and storing program guide data.

At present, commercialized products or devices that are capable of providing a program guide editing function are scarce. The PSIP Builder Pro product manufactured by triveni DIGITAL Company in the United States is an example. This product includes a television program editing device and a transport stream packets generating device.

The above-mentioned PSIP Builder Pro product by triveni DIGITAL Company is designed for use by a single broadcaster. The entire process, from collection of program guide data to generation of program guide transport stream data packets, is performed within the same device. Hence, there exist the following problems:

1. The device cannot integrate program guide data of different broadcasters and television stations. The signal broadcast by each broadcaster and television station includes only its own program guide data. Therefore, viewers have to tune in to different channels in order to view the program guides of different channels, which is very inconvenient.

2. In digital television broadcasting, the number of virtual channels (sub-channels) in a 6-MHz physical channel is not fixed. The same physical channel may broadcast one television program (i.e., including only one virtual channel) at one time and may broadcast four or more television programs (i.e., including four or more virtual channels) at other times. Therefore, the prior program guide device that treat virtual channel as editing basis would befuddle the editor with respect to the usage of the broadcasting channel bandwidth such that the editor would be unable to optimize the use of broadcasting channels.

3. Likewise, since digital television broadcasting permits a television broadcasting channel to have different numbers of virtual channels at different broadcasting times, meaning a physical channel may be divided into one, four, or even more than ten virtual channels, there is a need for a good method of managing the relationship between physical channels and their many virtual channels. Existing television program editing devices are unable to express directly the organizational relationship between a physical channel and its virtual channels in terms of the design of the interface on the part of the editor.

### SUMMARY OF THE INVENTION

Therefore, the main object of the present invention is to provide an independent television program editing device that provides only editing function. Program data edited via the television program editing device are stored in a separate external storage device.

In order to overcome the aforesaid problems, the television program editing device according to the present invention includes:

an input portion for accepting addition, revision and deletion performed by the editor against programs, identity data inputted by the editor via the input portion being transmitted to an identity verification portion for identity verification, the program data edited by the editor via the input portion being transmitted to a data processing portion for processing;

the identity verification portion, which compares the identity data inputted by the editor and obtained via the input portion with identity data stored in the external storage device so as to verify the identity of the editor and whether the editor has sufficient authority to edit program guide data;

an internal data storage portion for storing program data read by a data access portion from the external storage device and transmitting the program data to the data processing portion for processing;

the data processing portion, which receives program guide data, changed by the editor via the input portion for transmission the changed data to a changed data buffer portion for storage and which organizes the program data for subsequent transmission to a display portion for display via the data access portion;

the changed data buffer portion, which stores data difference resulting from commands of program addition, revision and deletion from the editor and transmitted from the data processing portion so as to facilitate updating of the external storage device;

the data access portion, which serves as a communication interface between the display portion and the external storage device, the data access portion reading the identity data and program guide data from the external storage device into the internal data storage portion, transmitting the data in the changed data buffer portion for storage in the external storage device, and transmitting the program data to the display portion for display; and

the display portion, which displays the program data transmitted from the data processing portion via the data access portion for browsing by the editor.

By separating the television program editing device from the program guide data external storage device, the television program editing device and the external storage device can be formed as independent modules. As such, different television stations can each use a single independent television program editing device to edit and store data in the common external storage device. In other words, the program guide data of different television stations will be stored in the same external storage device. Therefore, the external storage device has the program guide data of all the television stations. These program guide data are provided to each of the television stations. In this way, the program guides included in the television signals broadcast by each of the television stations will include the program guide data of all the television stations.

In addition to processing data of physical channels, virtual channels and television programs, the data processing portion further provides a channel scheduling mechanism to enable the editor to schedule the virtual channels to be broadcast at different broadcasting schedules of a physical channel, or the broadcasting schedules for each virtual channel. Furthermore, the data processing portion organizes the program guide data, which include the relationship among physical channels, virtual channels and channel scheduling data, in a tree structure for transmission to the display portion so that the display portion can exhibit the program guide data in the tree structure to the editor.

According to the present invention, a television program editing device enables television broadcasters to edit digital television program guide data. The television program editing device utilizes a database on an external storage device to organize and integrate the program data of different digital television stations for submission to an EPG generating system so as to serve as a source for generating electronic program guide data packets. By configuring the television program editing device and the external storage device to be separate and independent modules, the program guide data of a number of television stations can be integrated, so that the program guide data broadcast by each of the television stations include the program guide data of all of the television stations. The television program editing device also provides a channel scheduling function, whereby the editor can plan the virtual channels to be broadcast during each broadcasting schedule for each virtual channel. (The virtual channel is a concept of logic, one virtual channel representing a part of the bandwidth of a physical channel.) In addition, the device includes a display portion that employs a three-tier tree structure to manage the organizational relationship among physical channels, their virtual channels and the broadcasting schedules for each virtual channel.

### BRIEF DESCRIPTION OF THE DRAWINGS

Other features and advantages of the present invention will become apparent in the following detailed description of the preferred embodiment with reference to the accompanying drawings, of which:

FIG. 1 is a system block diagram of the preferred embodiment of a television program editing device according to the present invention;

FIG. 2 is a schematic diagram illustrating multiple television program editing devices and an external storage device;

FIG. 3 is an operational flow chart of an identity verification portion according to the preferred embodiment of this invention;

FIG. 4 is a schematic view illustrating a tree structure for program guide data displayed by a display portion according to the preferred embodiment of this invention;

FIG. 5 is a schematic view showing channel schedule data displayed by the display portion according to the preferred embodiment of this invention in an expanded state;

FIG. 6 is a schematic view showing physical channel data displayed by the display portion according to the preferred embodiment of this invention;

FIG. 7 is a schematic view showing virtual channel data displayed by the display portion according to the preferred embodiment of this invention;

FIG. 8 is a schematic view showing scheduled broadcasting schedule data displayed by the display portion according to the preferred embodiment of this invention;

FIG. 9 is a schematic view showing program data displayed by the display portion according to the preferred embodiment of this invention;

FIG. 10 is an operational flow chart of a program data editing portion according to the preferred embodiment of this invention;

FIG. 11 is a diagram showing a data processing portion with six sub-processing portions according to the preferred embodiment of this invention;

FIG. 12 is a flow chart depicting in detail the operation of the program data editing portion in step S204 of FIG. 10; and

FIG. 13 is a diagram illustrating a changed data buffer portion with three sub-buffer portions according to the preferred embodiment of this invention.

### DETAILED DESCRIPTION OF THE PREFERRED EMBODIMENT

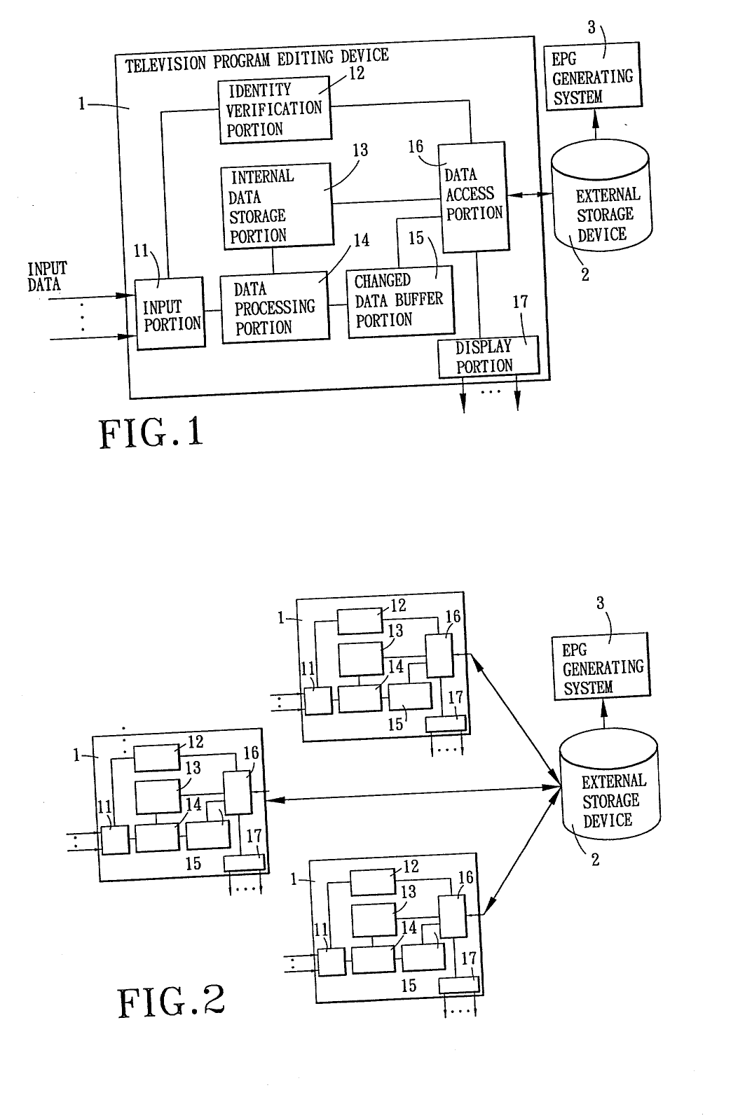

FIG. 1 is a system block diagram of the preferred embodiment of a television program editing device according to the present invention. In FIG. 1, 1 denotes the television program editing device for editing and browsing of program information by the editor. An external storage device 2 stores channel and program related data edited by the editor. The external storage device 2 supplies the data to an EPG generating system 3. The EPG generating system 3, based on a digital television specification format, converts the program guide data into transport stream data packets, which are provided to multiplexing equipment at television stations. The television program editing device 1 includes the following components:

11 denotes an input portion including input devices, such as a keyboard;

12 denotes an identity verification portion for verifying the identity and scope of authorization of the editor;

13 denotes an internal data storage portion for storing program guide data read from the external storage device 2;

14 denotes a data processing portion for processing data inputted via the input portion and organizing program data for browsing by the editor;

15 denotes a changed data buffer portion for temporarily storing editing operations (including addition, deletion, or revision) made to the program guide data by the editor;

16 denotes a data access portion that serves as a communication interface between the television program editing device 1 and the external storage device 2;

17 denotes a display portion that includes an output device, such as a display.

FIG. 2 is a schematic view illustrating a plurality of television program editing devices 1 in relation to one external storage device. FIG. 2 shows that different television stations can use independent television program editing devices 1 to edit program guide data. These program guide data are stored in the same external storage device 2, thereby achieving the object of data integration.

At the start of editing, the editor must input his identity data via the input portion 11. The identity data include user name and password of the editor. Then, the identity verification portion 12 will proceed with verification of the editor's identity.

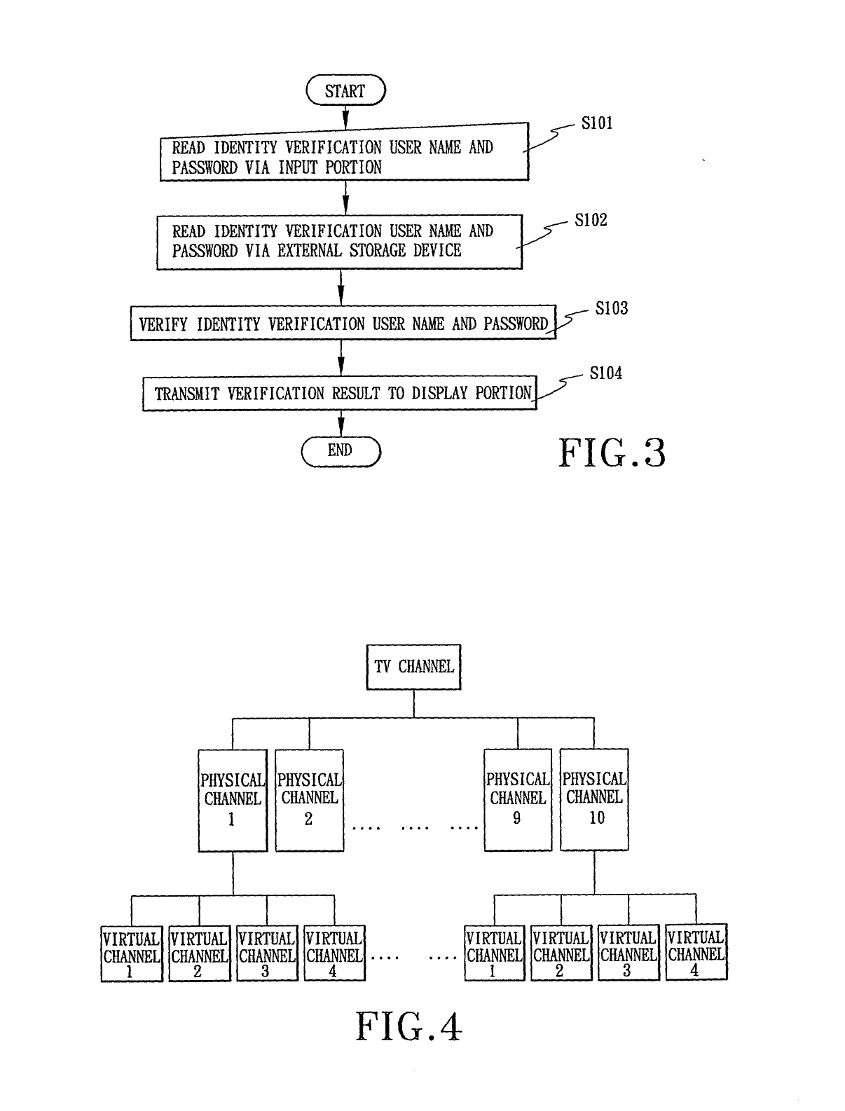

The process flow of the identity verification portion 12 is shown in FIG. 3. Initially, in step S102, the identity user name and password of the editor are obtained via the input portion 11. Then, step S102 is proceeded to retrieve user name and password data from the external storage device 2 via the data access portion 16. In step S103, the identity verification portion 12 compares the user name and password obtained via the input portion 11 with the user name and password data retrieved from the external storage device 2 to determine whether they match. Finally, in step S104, the identity verification portion 12, based upon the identity verification results, transmits the verification result to the display portion 17 via the data access portion 16 for display. If the editor cannot pass the identity verification, the editor will be informed of the verification failure via the display portion 17, and will be requested to input his identity data via the input portion 11 once again. If the editor successfully passes the identity verification, the identity verification portion 12 will, according to the identity of the editor, inspect the external storage device 2 as to the scope of authorization of the editor. If the editor has been given the authority to edit the program guide data, the editor will be permitted to proceed with editing of the program guide data.

Before the internal data storage portion 13, the data processing portion 14, the changed data buffer portion 15 and the data access portion 16 are discussed in greater detail, background information of the digital television program guides will be described first. In the conventional analog television broadcasting, a television station that has been assigned a bandwidth of 6 MHz can broadcast only one standard definition television program. Therefore, there is a very clear relationship between a television channel (physical channel) and a television program. However, under the digital television standard, one bandwidth of 6 MHZ can permit broadcasting of four standard definition television programs simultaneously (each program appearing on a different virtual channel). If a television station allocates a portion of the bandwidth to other services that require a much smaller bandwidth, for instance, pure musical programs or data broadcasting services, the amount of programs and services provided by the television station at a certain time will not be just four. Therefore, the organizational relationship between the television stations and the programs becomes more complicated. In order to more clearly express the organization relationship between the television physical channels and their virtual channels, the television program editing device according to the present invention employs a three-tier tree structure, as shown in FIG. 4. The first tier represents a starting node of the tree structure. The starting node branches downward to form the second tier. The second tier represents all the television physical channels. Each node in the second tier represents a 6-MHz physical channel. As every 6-MHz physical channel can broadcast four television programs of standard definition picture quality simultaneously, each 6-MHz node in the second tier can have four sub-nodes branched therefrom. Each sub-node represents a virtual channel. Each virtual channel can be used to broadcast a television program at one time. Therefore, based on this tree structure, the editor can understand the relationship between all the physical channels and their virtual channels.

In addition, the number of virtual channels of each 6-MHz physical channel may vary at different times. For instance, physical channel 1 broadcasts four standard definition television programs from 6 a.m. to 12 noon, one high definition television program from 12 noon to 4 p.m., and four standard definition television programs from 4 p.m. to 12 midnight, with no programs from 12 midnight to 6 a.m. This means that from 6 a.m. to 12 noon, physical channel 1 has four virtual channels; from 12 noon to 4 p.m., physical channel 1 has only one virtual channel; and from 4 p.m. to 12 midnight, physical channel 1 has four virtual channels again, and physical channel 1 does not have any virtual channel from 12 midnight to 6 a.m. Under these circumstances, the television station having physical channel 1 can have two options, as set forth below:

The first option is that the virtual channels are named using the names of the four virtual channels, e.g., virtual channel 1, virtual channel 2, virtual channel 3 and virtual channel 4. If this option is adopted, the broadcasting schedules for virtual channel 1 is from 6 a.m. to 12 midnight, and the programs broadcast from 12 noon to 4 p.m. is high definition programs, whereas that of the programs broadcast at other times is standard definition programs. The broadcasting schedules for all of virtual channel 2, virtual channel 3 and virtual channel 4 is from 6 a.m. to 12 noon, and from 4 p.m. to 12 midnight, and the programs broadcast are of standard definition programs. The problem with this option is that after commencement of digital television broadcasting, the total number of virtual channels of each physical channel could be quite large. Since a television station or viewers in general would like the name of a virtual channel to be associated with the type of programs played on the virtual channel to a certain extent, the use of the same name for virtual channel 1 that broadcast programs of both high and standard picture quality would confuse the viewers.

The second option is to use the names of five virtual channels to name the virtual channels, e.g., virtual channel 1, virtual channel 2, virtual channel 3, virtual channel 4 and virtual channel 5. The first four are used to name virtual channels that broadcast standard definition programs. The last one is used to name the virtual channel that broadcast high definition programs. If this option is adopted, the broadcasting schedules for all of virtual channel 1, virtual channel 2, virtual channel 3 and virtual channel 4 is from 6 a.m. to 12 noon, and from 4 p.m. to 12 midnight, and the picture quality of the broadcast programs is standard definition. The broadcasting schedule for virtual channel 5 is from 12 noon to 4 p.m., and the picture quality of the broadcast programs is high definition. The problem with this option is that for the same physical channel, the names of the virtual channels will be a lot, and the broadcasting schedules for virtual channels will be rather confusing.

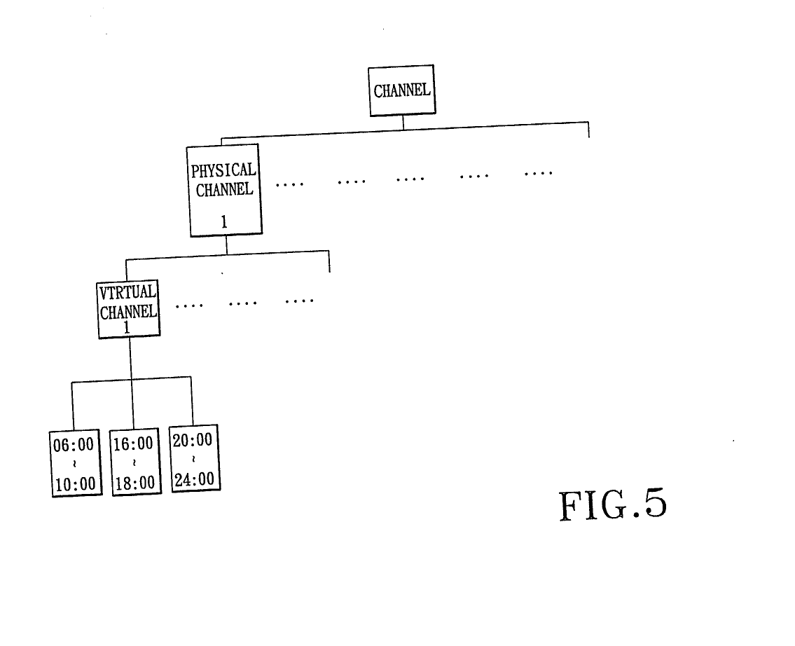

However, no matter which option a television station adopts in naming its virtual channels, the broadcasting schedules for virtual channels belonging in the same physical channel may be divided into several discontinued broadcasting schedules. Therefore, the data processing portion 14 according to this invention provides a “channel scheduling” mechanism. Through this mechanism, the editor can effectively manage the relationship of each broadcasting schedule of a virtual channel. In addition, the relationship between one virtual channel and each of its broadcasting schedules within the same day can also be clearly expressed by adding one tier to the aforesaid tree structure below the tier of virtual channels, as shown in FIG. 5.

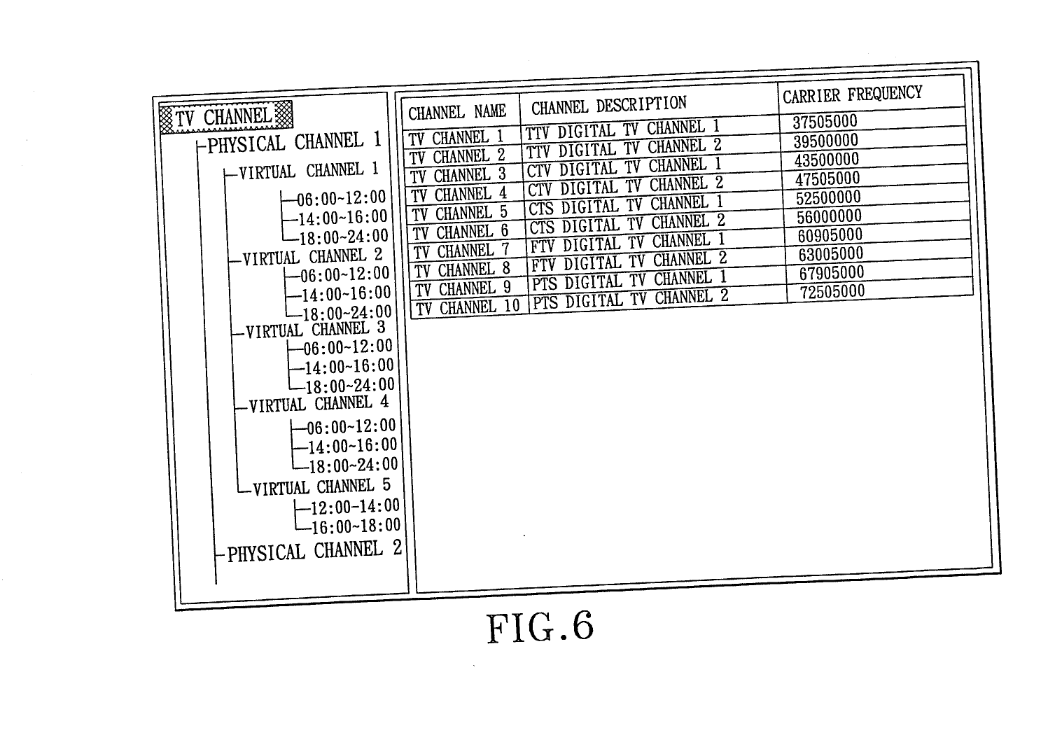

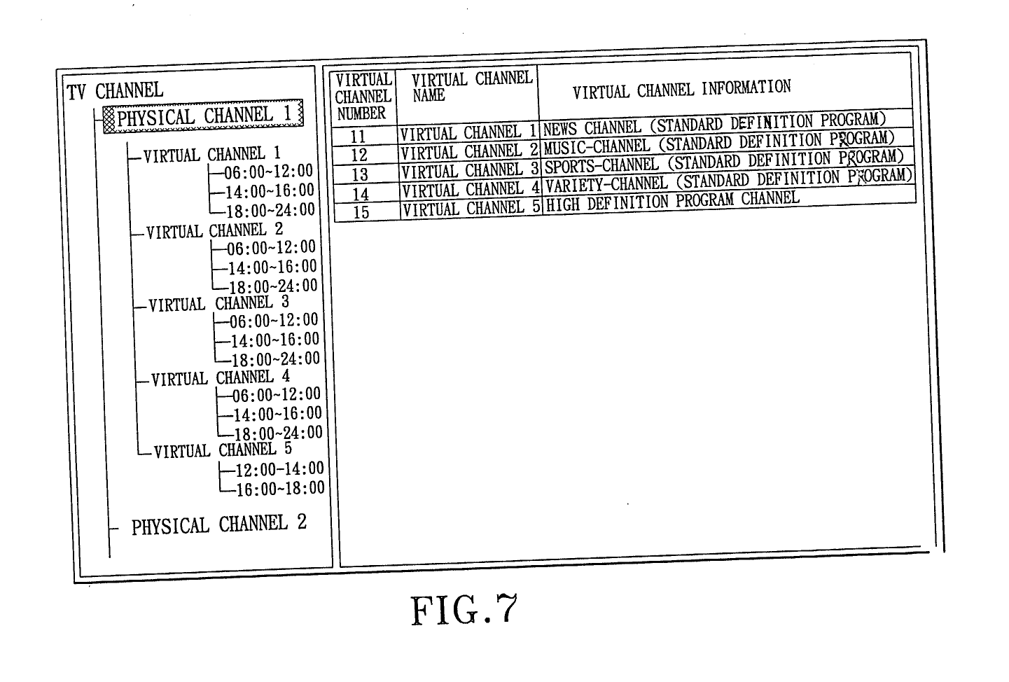

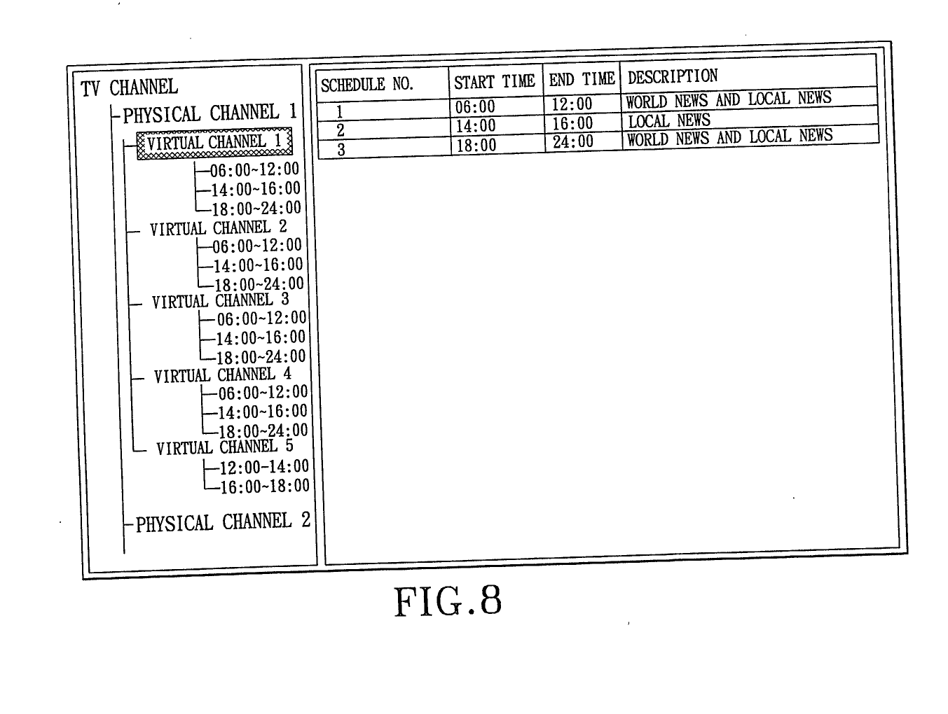

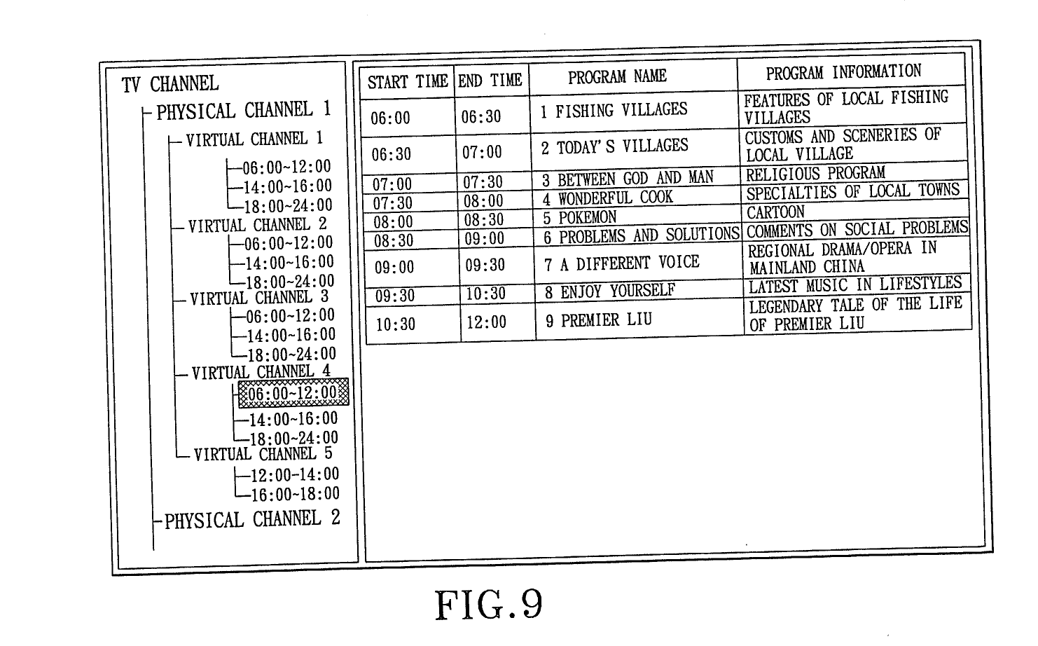

FIG. 6 is an example of representing the display portion. Shown on the left is a tree structure of the relationship between channels and broadcasting schedules. On the right, the detailed data corresponding to a certain node of the tree structure on the left. For instance, as shown in FIG. 6, as the node of “TV channel” shown on the left is selected, the detailed data of all the physical channels are displayed on the right. In FIG. 7, the node “Physical channel 1” on the left is selected. Therefore, the data of all the virtual channels of physical channel 1 are shown on the right. In FIG. 8, the node “Virtual channel 1” on the left is selected. Therefore, the broadcasting schedule data of virtual channel 1 are shown on the right. In FIG. 9, schedule 1 of the node “virtual channel 4” on the left is selected. Therefore, the data of all the programs of virtual channel 4 that are broadcast within schedule 1 are displayed on the right.

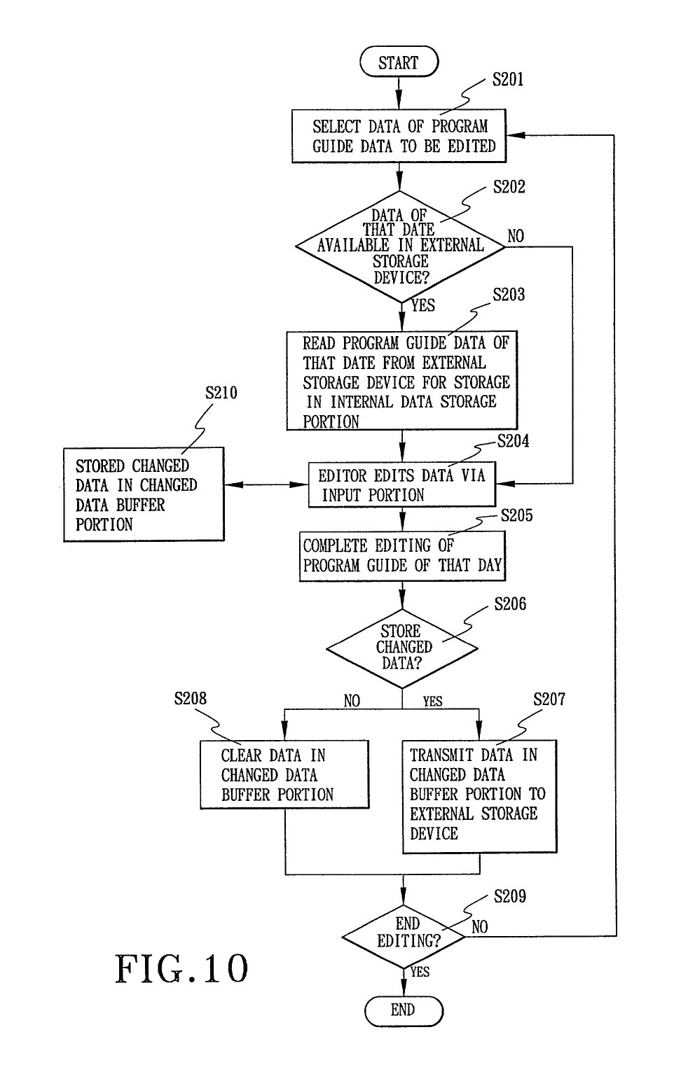

The editing flow of program guide data is illustrated in FIG. 10. Initially, in step S201, the editor specifies the date of the program guide data desired to be edited. Then, in step S202, the data processing portion 14 inspects as to whether program guide data of the specified date are available in the external storage device 2. If the program guide data of the specified data are not available in the external storage device 2, step S204 is proceeded, in which the data processing portion 14 sets the input portion 11 to a state for start of editing. If the program guide data of the specified date are available in the external storage device 2, step S203 is proceeded, in which the data processing portion 14 reads these data from the external storage device 2 and stores these data in the internal data storage portion 13. Then, the data processing portion 14 transmits the data within the internal data storage portion 13 to the display portion 17. Next, step S204 is proceeded, in which the input portion 11 is set to the state for start of editing (step S204 will be described in greater detail hereinafter) Data editing operations include addition, revision and deletion. The data to be edited include physical channel data, virtual channel data, and program data. Newly added data will be recorded in the changed data buffer portion 15 through the data processing portion 14 in step S210. Revised data, together with the original data prior to revision, will be recorded in the changed data buffer portion 15 for transmission back to the external storage device 2 such that the external storage device 2 can change the original data correctly. Index portions of the deleted data will also be recorded in the changed data buffer portion 15 for transmission back to the external storage device 2 such that the external storage device 2 can locate the data correctly and delete the same. The changed data buffer portion 15 permits change of data in batch operations and provides a buffer region. Since the unit of the program guide data provided by a television station is habitually the program data of a virtual channel for one day, the unit of batch editing operation performed by the data processing portion 14 according to the present invention is also the program data of a virtual channel for one day. In step S205, when the editor decides to end editing of the program guide data of that date, the data processing portion 14 in step S206 will inquire of the editor as to whether the changes to the program guide data are to be stored. If the editor opts to store the changes to the program guide data, step S207 is proceeded, in which the data processing portion 17 transmits the data in the changed data buffer portion 15 to the external storage device 2 for updating of the program guide data. Subsequently, the data processing portion 14 will clear the data in the changed data buffer portion 15. If the editor opts not to store the changes to the program guide data, step S208 is proceeded, in which the data processing portion 14 will clear the data in the changed data buffer portion 15 directly. Thereafter, step S209 is proceeded, in which the data processing portion 14 inquires of the editor as to whether editing of other program guide data is to be proceeded. If the editor opts to continue with editing, the flow returns to step S201, in which the data processing portion 14 inquires of the editor about the date to be edited. If the editor opts not to continue with editing, the program editing operation will end.

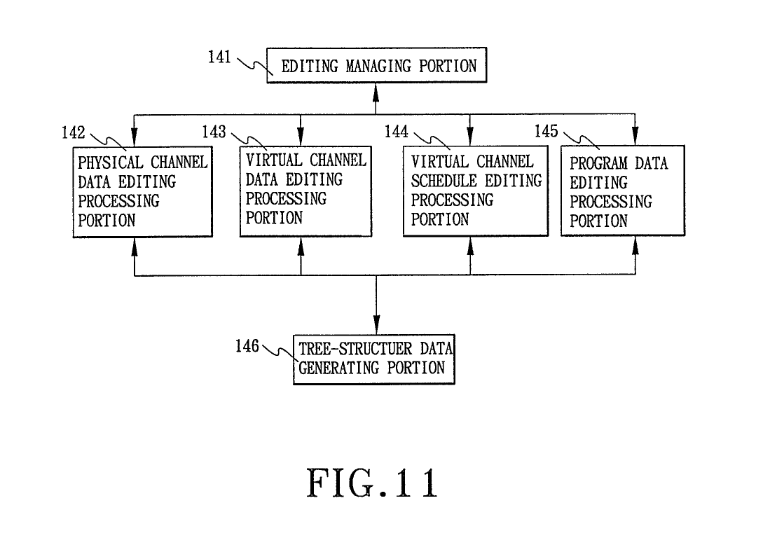

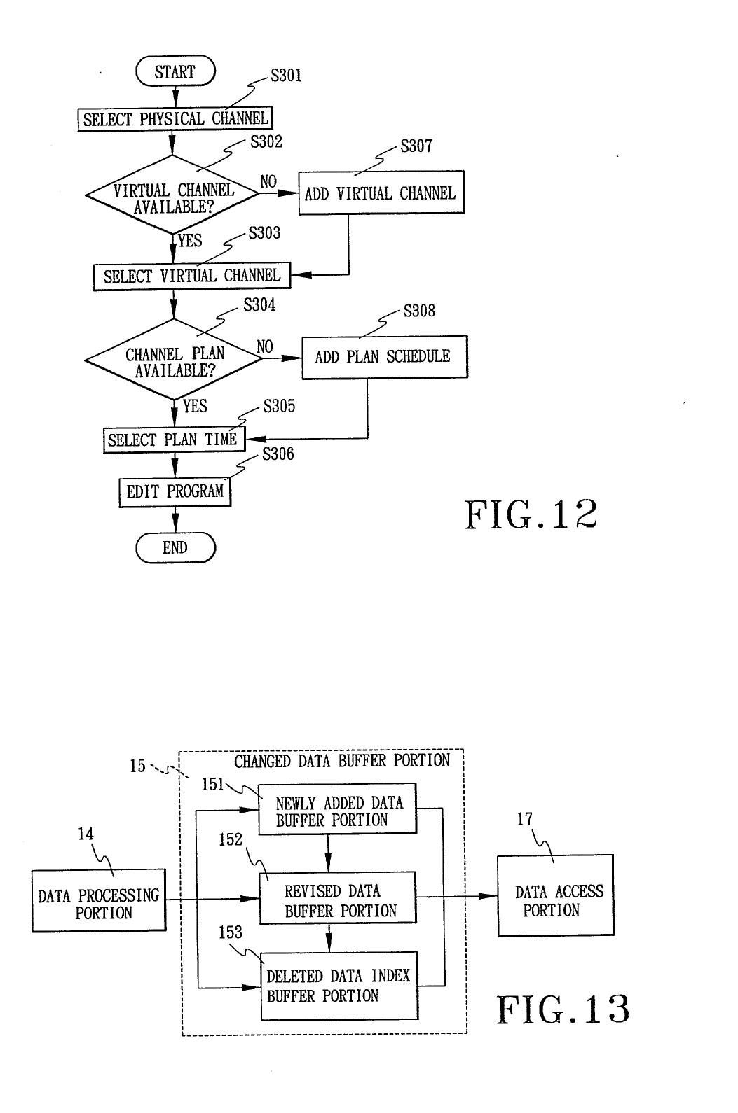

In order to provide the aforesaid tree structure for the editor to edit channel and program data, the data processing portion 14 can be further divided into six sub-processing portions according to different functions, as shown in FIG. 11, namely an editing managing portion 141, a physical channel data editing processing portion 142, a virtual channel editing processing portion 143, a virtual channel schedule editing processing portion 144, a program data editing processing portion 145 and a tree structure data generating portion 146. The step S204 shown in the flowchart of FIG. 10, i.e., the step of the editor's operation of editing the program guide data, is depicted in greater detail in FIG. 12. In FIG. 12, upon entry into the editing process flow, the editing managing portion 141 organizes the program guide data for subsequent transmission to the display portion 17 via the data access portion 16. The display portion 17 has two main display areas, left and right. The tree structure data generating portion 146 displays in a tree structure for all the television physical channels that can be edited by the editor within his scope of authorization on the left display area. The editor can expand each of the nodes in the tree structure to browse the physical channels, virtual channels, and the relationship between a virtual channel and its broadcast schedules. As shown in FIG. 12, in step S301, the editing managing portion 141 requests the editor to select the physical channel to be edited. The editor selects the physical channel to be edited from the tree structure shown on the left display area. After the editor has specified the physical channel to be edited, step S302 is proceeded, in which the physical channel data editing processing portion 142 inquires of the external storage device 2 as to whether there are available in the external storage device 2 virtual channel data with regard to the television channel selected by the editor. If there are available virtual channels, the virtual channel data of the selected television channel will be listed on the right display area. If there is no virtual channel, step S307 is proceeded, in which the editing managing portion 141 will request the editor to add virtual channel data. After the virtual channel data editing managing portion 143 has completed processing the virtual channel data added by the editor, step S303 is proceeded, in which the editor has to select a virtual channel. After the editor has specified the virtual channel to be edited, step S304 is proceeded, in which the virtual channel data editing processing portion 143 inquires of the external storage device 2 as to whether the virtual channel has available virtual channel schedule data. If yes, the virtual channel schedule data of the selected virtual channel will be shown on the right display area. Otherwise, step S308 is proceeded, in which the editing managing portion 141 requests the editor to add virtual channel schedule data. After completion of the adding of virtual channel schedule data, step S305 is proceeded, in which the editor needs to select a virtual channel schedule. After selection of a virtual channel schedule, if any program is already present in the virtual channel schedule, the right display area will show the program data of the selected virtual channel schedule via the virtual channel schedule editing processing portion 144. At this time, step S306 is proceeded, in which the editor proceeds with such operations as addition, deletion and revision against the programs. The program data editing processing portion 145 will transmit the data changed by the editor to the changed data buffer portion 15.

The data required to be recorded when the changed data buffer portion 15 processes different editing operations vary. For instance, for the program data newly added by the editor, the changed data buffer portion 15 needs to record the program data entry fully in the changed data buffer portion 15. For program data revised by the editor, only the differences between the original program data and the program data after revision needs to be recorded. For the program data that are deleted by the editor, only the index portions of the deleted program data entry needs to be recorded. Therefore, as shown in FIG. 13, the changed data buffer portion 15 can be further divided into three sub-buffer portions: newly added data buffer portion 151, revised data buffer portion 152 and deleted data index buffer portion 153. The newly added data buffer portion 151 stores the program guide data added by the editor. The revised data buffer portion 152 stores differences between the revised program guide data and the original copy of those data. The deleted data index buffer portion 153 stores indexes of temporarily deleted program guide data.

The present invention is not limited to the above-described embodiment and can be practiced without departing from the scope thereof. For instance, while the input portion provides a virtual channel scheduling function, the editor can, aside from specifying the broadcast start and end times of programs, further specify that a certain program be broadcast daily, weekly or monthly.

In view of the aforesaid, the present invention has the following advantages:

(1) The television program editing device according to the present invention and the external storage device are independent modules. An independent external storage device is used as a program guide data center for storing data from multiple television stations. Thus, data integration can be achieved. The integrated program guide data can then be supplied to each of the television stations so that the program guide data broadcast by each of the television stations are not limited to those of its own and include the program guide data of other television stations.

(2) The television program editing device according to the present invention provides a channel scheduling function to enable the editor to plan the broadcasting schedule of each virtual channel, and to clearly display which virtual channels are providing program services in different broadcasting schedules on a physical channel within the same day.

(3) The television program editing device according to the present invention employs a three-tier tree structure to clearly indicate the organizational relationship among physical channels, their virtual channels and channel schedules.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A television program editing device applied to a digital television broadcasting end and a television station for editing digital television electronic program guides, program data edited by an editor being stored in an external storage device, said television program editing device comprising:
an input portion for accepting commands, including program addition, revision and deletion from the editor, identity data inputted by the editor via said input portion being transmitted to an identity verification portion for identity verification, the program data edited by the editor via said input portion being transmitted to a data processing portion for processing;
said identity verification portion, which compares the identity data inputted by the editor and obtained via the said input portion with identity data stored in the external storage device so as to verify the identity of the editor and whether the editor has sufficient authority to edit program guide data;
an internal data storage portion for storing program data read by a data access portion from the external storage device and transmitting the program data to said data processing portion for processing;
said data processing portion for organizing the program data for subsequent transmission to a display portion and receiving program data changed by the editor via said input portion so as to transmit the changed data to a changed data buffer portion for temporary storage;
said changed data buffer portion, which stores difference data resulting from commands of program addition, revision and deletion from the editor and transmitted from said data processing portion so as to facilitate updating of the external storage device;
said data access portion, which serves as a communication interface between said display portion and the external storage device, said data access portion reading the identity data and program guide data from the external storage device into said internal data storage portion, transmitting the data in said changed data buffer portion for storage in the external storage device, and transmitting the program data to said display portion for display; and
said display portion, which displays the program data transmitted from said data processing portion for browsing by the editor.

2. The television program editing device according to claim 1, wherein said data processing portion includes:
an editing managing portion for processing the program guide data edited and changed by the editor via said input portion, the changed program guide data being passed to a corresponding editing processing portion for further processing;
a physical channel data editing processing portion for processing basic information of a physical channel and relevant information of virtual channels thereof;
a virtual channel data editing processing portion for processing basic information of virtual channels and relevant information of channel schedules thereof;
a virtual channel schedule editing processing portion for processing relevant information of virtual channel schedules;
a program data editing processing portion for processing relevant information of television programs; and
a tree-structure data generating portion for organizing physical channel data, virtual channel data and channel schedule data into a tree structure for transmission to said display portion.

3. The television program editing device according to claim 1, wherein said changed data buffer portion includes:
a newly added data buffer portion for storing newly added program guide data;
a revised data buffer portion for storing differences between revised program guide data and an original version of the revised program guide data; and
a deleted data index buffer portion for storing indexes of temporarily deleted program guide data.
